(19) United States
(12) Patent Application Publication
(10) Pub. No.: US 2001/0024587 A1
(43) Pub. Date: Sep. 27, 2001

(54) Franking machine with language switching

(75) Inventors: Roland Fischer-Wasels, Berlin (DE); Peter Storck, Berlin (DE)

Correspondence Address: SCHIFF HARDIN & WAITE, 6600 SEARS TOWER, 233 S WACKER DR, CHICAGO, IL, 60606-6473, US

(73) Assignee: Francotyp-Postalia AG & Co.

(21) Appl. No.: 09/808,611

(22) Filed: Mar. 14, 2001

(30) Foreign Application Priority Data
Mar. 15, 2000 (DE) 100 12 518.2

(51) Int. Cl. B41J 2/00

(52) U.S. Cl. 400/103; 400/104; 400/76

(57) ABSTRACT

A franking machine for franking mail items has a user interface for operating the franking machine, in particular for inputting and displaying franking parameters and operating steps. In practice, it has often proven to be difficult to operate a franking machine if all texts are displayed in a foreign language. In particular maintenance of a franking machine then also entails serious difficulties. That becomes a problem in particular when the texts in that respect are still displayed in completely foreign characters, for example in the Chinese language. In order to overcome problems of that kind, the franking machine according to the invention has language-switching circuit for switching over the language used in the user interface, which are such that language switching can be effected at any time. Thus, it is possible at any time and using simple means to switch over to another language without the user having to go to a specific language selection menu and without having to change the program for operation of the franking machine or the user interface.

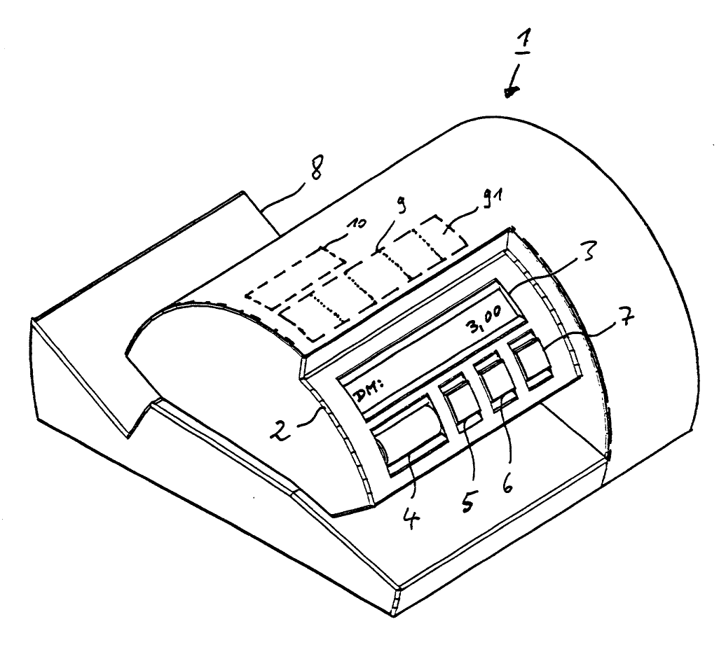

### BACKGROUND OF THE INVENTION

1. Field of the Invention

The invention concerns a franking machine for franking mail items comprising a user interface for operation of the franking machine, in particular for the input and display of franking parameters and operating steps.

2. Description of the Prior Art

Modern franking machines have a user interface with input and display means. They serve to input franking parameters such as, for example, the kind of dispatch, the weight and the franking value or to select such parameters from suitable selection menus and also suitably display same. In that respect it is also possible to display corresponding input requests and other operating steps. Franking machines of the type are generally operated with a microprocessor, wherein the texts for the display are stored in a memory region to which the microprocessor has access in order to display those texts in dependence on the context of operation.

A franking machine having a user interface is known from European Application 491 392 A2. In that arrangement the texts intended for display are stored in two difference languages, wherein the language used for the display is set when the franking machine is brought into operation for the first time or is selected when the franking machine is switched on the basis of a user identification code which must be inputted by a user. All texts are then displayed in that language during operation of the machine.

The language in which the texts are displayed consequently depends on the language in which the program for operation of the user interface was prepared and/or the language which was selected from a configuration menu which is possibly available. In the operation of known franking machines, however, the following disadvantages occur in connection with language selection or language switching:

1. Selecting the language when producing the program involves the disadvantage that the franking machine or the user interface must have a different program if the language is to be changed. Such a program change cannot be implemented by the user of the franking machine.

2. Selecting the language from a configuration menu is disadvantageous insofar as the user must go to a specific menu in order to be able to implement selection of the language. That language selection menu however can under some circumstances only be reached by way of a plurality of operating steps which are then only displayed with texts in a language which the user may not know.

3. Language selection is particularly difficult in that case when those texts are additionally displayed in a completely different font, for example it is very difficult for a European to read the characters of the Chinese language if he or she is not conversant with that language. The operating steps for language switching can be described in the operating instructions so that the user is then “flying blind” to go to the appropriate speech selection menu in order to change over to a language which he or she knows. Such a solution, however, is not particularly simple and satisfactory. Since the characters and texts in different languages require a different font and thus different character sizes, the program must be suitably matched to the respective language in order to represent the different character sizes. That means that the complication and expenditure for representation with each font is increased.

### SUMMARY OF THE INVENTION

An object of the present invention is to provide a franking machine with a simple option for language switching.

The above object is achieved in accordance with the principles of the present invention in a franking machine for franking mail items having a user interface for operating the franking machine, for entering and displaying franking parameters and operating steps, wherein the user interface has a language-switching unit for switching a currently-employed language used in the user interface from among a number of available languages, and wherein the switch from one language to another via the language-switching unit can be undertaken at any arbitrary time.

The franking machine according to the invention makes it possible to change over the language at any time during use of the franking machine in a simple manner. It is not necessary that, for language switching purposes, for the user to go to a specific menu, that requires a number of steps for language switching purposes or which makes language switching possible only by simultaneously changing the program. For the purpose the texts intended for display are stored in parallel in various languages, so that upon actuation of the language-switching circuit, the same text is simply selected in a different language and displayed.

An embodiment wherein an actuatable element is provided to switch the language switching circuit achieves a simple implementation of the language-switching actuator. In that way, it is possible to change over the language at any time by actuation of the language-switching device which is specifically provided for switching over the language. In particular the language-switching actuator can be in the form of a specific key or button or a specific key or button combination comprising two or more keys or buttons, each of which in itself entails a different function. Alternatively, the language switching can be triggered by pressing a specific button for a number of seconds.

In a further embodiment, it is possible to switch among a number of available languages until the desired language is found, by actuating the language-switching circuit a number of times. The larger the number of languages available in that respect, the more operationally universal the franking machine can be. This also facilitates, for example, repair of a franking machine which is operated in China, by a service engineer who is only proficient in the English language.

In a particularly simple arrangement, all texts intended for display in the available languages are stored in parallel in a memory which is specifically provided for that purpose in the user interface, in which respect it is possible to provide a separate memory cell for storing the language which is selected at the present time, or an identification in respect thereof.

In order not to have to adapt the program for the display of texts and for the representation of different font sizes when switching over into another language, for example when switching from the English to the Chinese language, in a further embodiment all texts which are displayed are at a maximum of the size of a display device provided in the user interface. That means that the height and width of texts in all languages are adapted to the size of the display device.

### DESCRIPTION OF THE DRAWING

The single figure is a perspective view, showing certain internal components, of a franking machine constructed and operating in accordance with the principles of the present invention.

### DESCRIPTION OF THE PREFERRED EMBODIMENTS

The franking machine 1 has a user interface 2 with a display device 3. A number of buttons 4 through 7 are provided for operation and input of franking parameters. By means of a rolling key 4, the setting for a franking parameter, for example as shown the franking value, can be altered by scrolling through predetermined values. Confirmation of a displayed value can be effected by the confirmation button 5, whereby at the same time the arrangement switches over to another menu or to another franking parameter. Printing of the franking can be triggered by the print button 6. In addition, provided as the language-switching means is a special language-switching button 7 which makes it possible to switch over the language of the text displayed in the display device 3, at any moment in time. In this case, the machine switches over to the next available language by pressing the button 7 once, in which case, after the last available language is reached, the machine is switched over into the first language again. For the franking operation, the mail item is introduced into the receiving device 8 which is specifically provided for that purpose. In addition there is a memory 9 for storage of the texts intended to be displayed, in the various languages. Control of machine operation and display of the texts is effected by way of a microprocessor 10.

When producing the program for controlling operation and the display of texts, two or more memory regions, depending of the respective number of available languages, are produced in the memory 9, and are accessible to the microprocessor 10. The texts of the various languages are stored therein in such a way that they are each in the same sequence in parallel relationship in the individual memory regions, or that there exists a list giving an unequivocal association of the texts in the various languages. By way of the content of a memory unit 91 which is specifically provided for that purpose, the microprocessor can decide from which memory region, that is to say in which language, a text is to be displayed in the display device 3. When switching over the language, that memory unit 91 is written to in dependence on the language selection and read upon the output of a text by the microprocessor.

An unambiguous signal or event is established in order to trigger off the language switching procedure. As the object in this respect is to be able to implement language switching in any context of the user interface, that signal or event is not to entail any other function or is not to trigger off any other actions. In the illustrated case therefore, the arrangement has a specific language-switching button 7. It is, however, possible to envisage a large number of other options in this respect. For example, it is possible to provide an input which is specifically provided for that purpose on the microprocessor, the connected peripheral items (for example a network interface) or other input units. A combination of keys or buttons which must be pressed by the user simultaneously or within a given period of time also can be provided for the language-switching procedure. It is further possible for the event for language switching to be triggered only in dependence on one or more buttons after a given period of time, in which respect otherwise those buttons when used individually or in different combinations trigger different events. It is also possible to use, for example, existing PC buttons such as Shift, Control, Alt etc., in combination with one or more buttons, to trigger off the language-switching procedure. Thereupon the machine switches over from the language which is selected at the present time, to another language. In order to display, in the newly selected language the characters which are currently being displayed on the display device, the display contents will be refreshed with the newly selected language.

When producing the texts, for each text which contains written symbols, for example Chinese characters, the corresponding texts are also produced with other written symbols, for example the Latin alphabet for the German language. In that situation, all texts occupy only as much space on the display device, as is provided for display of the text in the other respective languages. These can, for example, also be abbreviations. If, for example, a Chinese character were to occupy double the width and height of a Roman letter, then the same context can occupy precisely double the width and height without anything having to be enlarged appropriately in terms of representation. This therefore ensures that the program to be executed, for display purposes, does not have to be supplemented or modified in order to display texts in a different language with different written symbols on the display device.

The invention is not limited to the illustrated embodiment. On the contrary, in terms of the specific configuration of the franking machine according to the invention and in particular in terms of the configuration of the user interface and the language-switching means, it is possible to envisage a large number of variations which are also encompassed within the invention.

We claim as our invention:

1. A franking machine for franking mail items having a user interface for entering and displaying franking parameters and operating steps, said user interface having a language-switching unit for switching a language currently used in said user interface to a different language, at any arbitrarily selected time.

2. A franking machine as claimed in claim 1 wherein said language switching unit has an actuator operable by a user which, when actuated, switches said currently used language to said different language.

3. A franking machine as claimed in claim 1 wherein said language-switching unit allows switching among a plurality of available language for selecting a desired language as said different language.

4. A franking machine as claimed in claim 3 wherein said language switching unit has a memory in which all texts to be displayed are stored in parallel in all of said available languages.

5. A franking machine as claimed in claim 4 wherein said interface allows display of a maximum size text, and wherein none of said stored texts exceeds said maximum size.

6. A franking machine as claimed in claim 4 wherein all of said texts are stored in said memory in each of said languages in a same sequence, AND wherein said texts are stored in said memory in each of said languages in a list uniquely corresponding the texts in each language to the texts in the other languages.

7. A franking machine as claimed in claim 1 wherein, upon a switch from said currently used language to said different language, any texts currently displayed at said interface in said currently used language are automatically displayed in said different language.

8. A franking machine as claimed in claim 7 wherein said language switching unit has an actuator which, upon successive actuations, alternatingly effects switching back and forth between said currently used language and said different language.

9. A franking machine as claimed in claim 7 wherein said language switching unit has a plurality of available languages stored therein and has an actuator which, upon successive actuation, cyclically scrolls through said plurality of languages.
